(19) United States
(12) Patent Application Publication
(10) Pub. No.: US 2013/0263161 A1
(43) Pub. Date: Oct. 3, 2013

(54) METHOD OF PROVISIONING ADDITIONAL STORAGE TO COMPUTER APPLICATIONS

(71) Applicants: Narsimha Reddy Challa, Hyderabad (IN); Sudheer Yetukuri, Hyderabad (IN); Man Singh Sardar, Hyderabad (IN)

(72) Inventors: Narsimha Reddy Challa, Hyderabad (IN); Sudheer Yetukuri, Hyderabad (IN); Man Singh Sardar, Hyderabad (IN)

(73) Assignee: HEWLETT-PACKARD DEVELOPMENT COMPANY L.P., Houston, TX (US)

(21) Appl. No.: 13/884,570

(22) PCT Filed: Dec. 20, 2010
(86) PCT No.: PCT/IN2010/000828

§ 371 Date: May 9, 2013

(51) Int. Cl. G06F 9/54

(52) U.S. Cl. CPC G06F 9/544
USPC 719/328

(57) ABSTRACT

Provided is a method of provisioning additional storage to a computer application. The storage usage of a computer application is monitored to ascertain when a minimum storage requirement of the computer application is reached. Additional storage to the computer application is provisioned based on a storage policy applicable to the computer application, once the minimum storage requirement of the computer application is reached.

### BACKGROUND

One of the reasons for popularity of computers in a present day office is the availability of a wide range of diverse computer applications that could simplify human tasks in multiple ways. From a simple calculator application to an ERP (Enterprise Resource Planning) software, computer applications have come a long way in terms of their usefulness to an enterprise. However, with organizations increasingly becoming dependent on computers to organize their work, the number of computer applications involved in the maintenance of these tasks has grown manifold. So much so that storage of these computer applications has become a task itself.

In a typical scenario, the computer applications employed in an organization are hosted on various computer servers. These are also known as host computers. A computer server generally has a large storage area to host a single or multiple computer applications. With ever increasing computer applications required to be stored and managed by an enterprise, the business quickly took to the idea of setting up large data centers to host its applications and associated data. One of the main purposes of a data center is to run the applications that handle the core business and operational data of the organization. A large number of computer servers may be engaged for this purpose. Managing storage of computer applications on these servers is no trivial task.

### BRIEF DESCRIPTION OF THE DRAWINGS

For a better understanding of the solution, embodiments will now be described, purely by way of example, with reference to the accompanying drawings, in which:

FIG. 1 is a schematic block diagram showing a storage system according to an embodiment.

FIG. 2 is a schematic block diagram showing a storage server system according to an embodiment.

FIG. 3 shows a flow chart of a computer-implemented method for provisioning additional storage to a computer application according to an embodiment.

### DETAILED DESCRIPTION OF THE INVENTION

As mentioned earlier, managing a large number of computer applications on computer servers or storage devices is no mean task. Storage is always a critical resource for these applications. It is possible that a computer application may run out of storage space at any point of time. This could result in significant loss to an enterprise, especially if the computer application, which is down, happens to be a core application critical to the running of business operations. For example, if a customer data application for an online bookstore, which is responsible for obtaining and storing customer data, prior to an online purchase, runs out of storage space, it may lead to significant loss of revenue and profits for the business. Therefore, it is vital that computer applications are monitored for their utilization and requirement of their storage needs on regular basis. Manual checking of storage requirements of a large number of computer applications is a difficult and time consuming task. In some cases, it is practically impossible on a continuous basis.

Proposed is a solution that mitigates the prior art limitations of provisioning storage space to computer applications. Embodiments of the present solution provide a method and a system for provisioning additional storage space to computer applications.

Proposed solution has been illustrated below, as an example, in the context of an SRM (Storage Resource Management) application. However, the solution may be implemented as a standalone application or in conjunction with other computer applications.

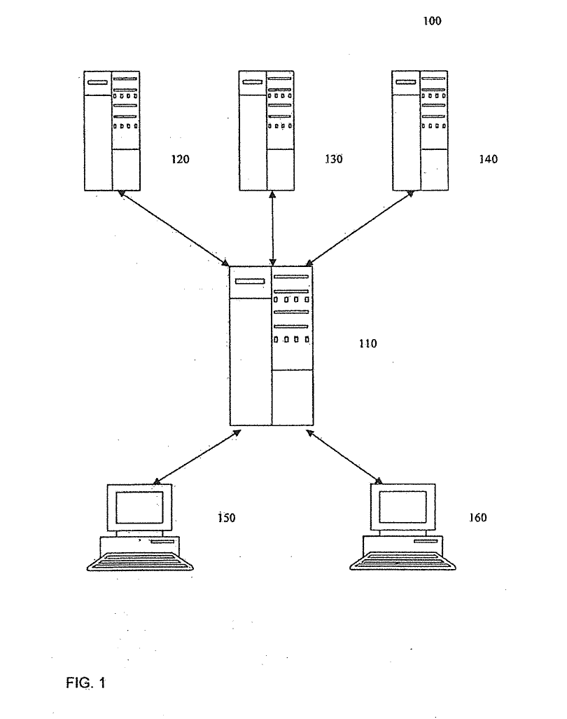

FIG. 1 is a schematic block diagram showing a storage system 100 according to an embodiment.

The storage system 100 includes storage resource manager server 110, storage devices 120, 130, 140 and client computer systems 150, 160.

The storage resource manager server 110 is connected to storage devices 120, 130, 140 and client computer systems 150, 160 through a network, which may be wired or wireless. The network may be a public network, such as, the Internet, or a private network, such as, an intranet. The number and type of storage devices 120, 130, 140 and client computer systems 150, 160, connected to storage resource manager server 110 is for the purpose of illustration only. The storage system 100 may include any number and type of storage servers and client computer systems.

The storage resource manager server 110 is responsible for monitoring and provisioning storage space in storage devices 120, 130, 140. It may allocate additional storage space to a computer application in response to a request from the computer application or a user of client computer system 150, 160. The storage resource manager server 110 may also include a database for storing various kinds of policies, which may be internal organizational policies or external client specific policies.

The client computer systems 150, 160 may be any kind of computing device, such as, but not limited to, a personal computer, a desktop computer, a laptop computer, a notebook computer, a network computer, a router, a switch, a personal digital assistant (PDA), a mobile device, a hand-held device, or any other suitable computing device. The client computer systems 150, 160, may host a single or multiple computer applications. The client computer systems 150, 160 may request the storage resource manager server 110 to allocate or provision storage in storage devices 120, 130, 140, for a computer application or applications.

The storage devices 120, 130, 140 may be any storage device, such as, but not limited to, disk arrays, tape libraries, optical jukeboxes, etc., accessible to a computer server(s). Typically, a storage area network (SAN) consolidates such storage devices together using a network. In an embodiment, the storage devices 120, 130, 140 are disk arrays which contain multiple disk drives.

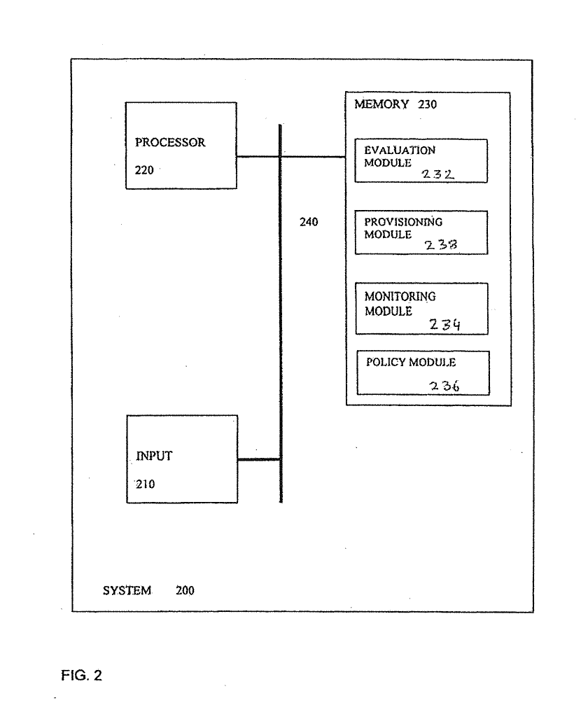

FIG. 2 is a schematic block diagram showing an embodiment of storage server system 110 of FIG. 1. The storage server system 200 may be any software/hardware system that serves the needs or requests of other client computer systems or applications. It may be connected to other computing devices through wired or wireless means. The storage server system 200 includes an input device 210, a processor 220 and a memory 230. These components may be coupled together through a system bus 240. In an embodiment, the storage server system 200 is a Storage Resource Manager (SRM) system.

The input device 210 may include a mouse, a key pad, a touch pad or screen, a voice recognizer, and the like. The input device may be used, inter alia, for providing minimum storage requirement of a computer application(s) by a user and defining storage policy applicable to a computer application.

The processor 220 is used to execute machine readable instructions. In an embodiment, the machine readable instructions may comprise, inter alia, instructions to monitor storage usage of the computer application to ascertain when a minimum storage requirement of the computer application is reached, to identify storage policy applicable to the computer application and to provision additional storage to the computer application, based on a storage policy applicable to the computer application, once the minimum storage requirement of the computer application is reached.

The memory 230 may include computer system memory such as, but not limited to, SDRAM (Synchronous DRAM), DDR (Double Data Rate SDRAM), Rambus DRAM (RDRAM), Rambus RAM, etc. or storage memory media, such as, a floppy disk, a hard disk, a CD-ROM, a DVD, a pen drive, etc.

In an embodiment, memory 230 may store an SRM (Storage Resource Management) application. An SRM application is typically responsible for optimizing the efficiency and speed with which the available drive space is utilized in a storage area network (SAN). It identifies underutilized storage resources and helps predict future storage requirements.

Also, in an embodiment, it is assumed that an SRM application has the following capabilities. First, the application is capable of discovering hosts and their storage details like LUNs (logical unit numbers), storage systems from which those LUNs were assigned, connectivity details like fabrics, switches, ports etc. from a SAN. Second, it is capable of discovering applications (file systems, databases etc.) and the LUNs assigned to them from SAN, discovering used space and free space etc. using application discovery agents. Third, it has a policy manager component or module. Fourth, the application is capable of having APIs (Application Programming Interface) to provision storage from various storage arrays.

The memory 230 may include an evaluation module 232, a monitoring module 234, a policy module 236 and a provisioning module 238. In an embodiment, the aforementioned modules may form a part of the SRM application.

The term “module”, as used herein, means, but is not limited to, a software or hardware component. A module may include, by way of example, components, such as software components, processes, functions, attributes, procedures, drivers, firmware, data, databases, and data structures. The module may reside on a volatile or non-volatile storage medium and configured to interact with a processor of a computer system.

The evaluation module 232 is responsible for determining the storage requirement of a computer application, which may be hosted on the client computer systems 150, 160. The evaluation module 232 determines the minimum value or percentage of free space that must be available at any given point of time for a computer application. Each computer application may have a different space requirement. Also, the amount of space required could vary based on an organization's policies or customer needs.

A topology manager (module) along with an API (Application Programming Interface) layer may help the evaluation module in the determination of storage space requirements of a computer application(s). A topology manager provides the details like storage supply chains from application to the storage LUN. This may consist of Host Volumes, HBAs, Fabric connectivity, storage LUNs presented to it. The API layer in the SRM application discovers the data for each managed element at configurable intervals and stores it in the database. It provides the API layer using which users can retrieve the details regarding the managed resources. For example, a call like GetAllStorageSystems( ) would report all the storage systems discovered by the SRM application. For each managed entity like application, the API would report the amount of storage allocated, used space and free space etc. Similarly, for provisioning new storage from managed storage arrays, the SRM solution may have an API layer to provision.

Further, the amount of space required by an application could be a default value, set by the application itself, or the value may be specified by a user, for example, an administrator. In case, the value is to be defined by a user, the storage server (for example, SRM server or system) may contain a user interface, for providing the same.

The monitoring module 234 is responsible for monitoring the storage space utilized by a computer application or applications. It monitors the present free space available for a computer application(s). The monitoring may take place against the minimum free space required by the computer application, as determined previously by the evaluation module.

The policy module 236 maintains the policies governing the allotment of storage space to a computer application or applications on a storage device, for example, storage devices 120, 130, 140. The policy module may also be referred as policy manager. It acts as an evaluation engine for policies. The user could define various policies which are monitored by a policy manager. When the condition for a particular policy is met then the actions associated with that policy will be enforced by the policy manager.

For the sake of clarity, a policy may be defined as a condition(s), which is associated with an action(s). When the condition for a particular policy is true, then the action(s) associated with that policy is executed, for example, by a policy module or a policy manager.

The provisioning module 238 is responsible for provisioning storage space to a computer application (or applications) as and when the minimum storage requirement of the computer application is reached. If upon monitoring, the monitoring module 234 comes to the conclusion that an application has reached the critical free space limits determined earlier, the monitoring module would check with the policy module 236 to determine the applicable policy. The policy module 236 would in turn advise the provisioning module to follow the policy. For example, if the policy states that additional space is to be allocated to the computer application, once its storage space requirement reaches a certain minimal level, the provisioning module 238 would provision additional space to the computer application accordingly. The provisioning module may provision additional storage space to from the storage devices 120, 130, 140, or any other storage system with free space (not illustrated).

In the context of an SRM application, the provisioning may involve the following sequence of steps using SRM APIs automatically, without a user's intervention. First, the policy module is accessed to obtain the policy related to the storage of a computer application. The storage devices (for example, storage arrays) from which the storage is to be provisioned are identified. If the first storage device does not have enough free space available, the provisioning is done from the next storage device identified earlier. Second, a LUN on the storage device is created using the API provided by SRM application. Third, the new LUN is assigned to the host using LUN Masking and Mapping operations. The new LUN visible in the host called Host LUN. Fourth, zoning configurations are created. Fifth, the new zone configurations are activated. Lastly, the Host LUN is assigned to the application.

It would be appreciated that the system components depicted in FIG. 2 are for the purpose of illustration only and the actual components may vary depending on the computing system and architecture deployed for implementation of the present solution. The various components described above may be hosted on a single computing system or multiple computer systems, including multiple servers, connected together through suitable means.

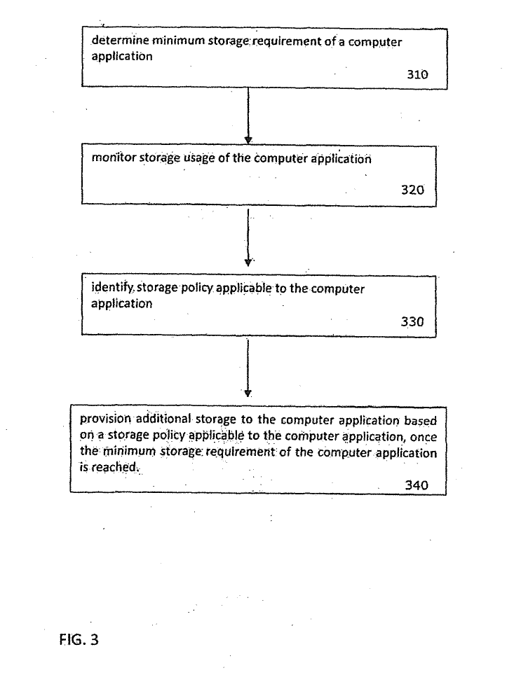

FIG. 3 shows a flow chart of a computer-implemented method for provisioning additional storage to a computer application according to an embodiment.

In an embodiment, the method may be implemented on the storage server 110. The method may begin (step 310) with determination of minimum storage requirement of a computer application residing on a host computer 150 (client computer system) connected to the storage server 110. If there are multiple computer applications residing on a host or multiple hosts 150, 160, then the step would involve determination of minimum storage requirement for each of the computer applications. An evaluation module may determine the minimum value or percentage of free space that must be available at any given point of time for a computer application.

Once the minimum storage requirement of a computer application(s) has been determined, the storage usage of a computer application(s) is/are monitored to ascertain whether a minimum storage requirement of a computer application(s) has reached or not (step 320). The monitoring may be done by the storage server on periodic basis or continuously.

If it is determined that a computer application(s) has/have reached the minimum storage requirement, the method identifies the storage policy applicable to the computer application (step 330). The storage policy for each computer application may be defined well in advance. A storage policy governs the allotment of storage space (or additional storage space) to a computer application or applications on a storage device. A user may define the storage policy applicable to a computer application.

In an embodiment, the storage policy may apply to more than one or a group of computer applications. Also, the computer applications may be grouped together based on: type of computer applications, a user associated with the computer applications, service level agreement (SLA) and/or an organization's policies. The basis of grouping of applications and applicable storage devices may also be defined in the storage policy. When the condition for a particular policy is met then the actions associated with that policy are enforced.

Step 340 involves provisioning of additional storage space to the computer application once the minimum storage requirement of the computer application is reached. The additional storage space to the computer application is provisioned based on the storage policy applicable to the computer application. The additional storage space may be provisioned on at least one storage device 120, 130, 140. The storage policy may also specify on which storage device the provisioning of additional storage is to be made. Further, the policy may also categorize the available storage devices based on their cost. In one example, the additional storage to a computer application may be provisioned based on the cost of the storage device.

In another embodiment, the provisioning of additional storage to a computer application may be made the criticality of the computer application. For example, a less critical application (not core the functioning of a business) may be given additional storage on a low cost storage device. On the other hand, a relatively critical application (core to the functioning of a business) may be given additional storage on a high cost storage device.

The embodiments described provide an effective mechanism to assign storage space to computer applications, for example, in a data center environment. By enhancing, for example, an SRM application, with the proposed solution, enterprises could benefit by reducing the downtime of critical applications and proper utilization of storage resources. This could save costs associated with storage and offer better return on investments.

It will be appreciated that the embodiments within the scope of the present solution may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present solution may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present solution is for the purpose of illustration only. Although the solution has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present solution.

1. A computer-implemented method of provisioning additional storage to a computer application comprising:
monitoring storage usage of the computer application to ascertain when a minimum storage requirement of the computer application is reached; and
provisioning additional storage to the computer application, based on a storage policy applicable to the computer application, once the minimum storage requirement of the computer application is reached.

2. A method according to claim 1, further comprising, prior to the monitoring step, determining minimum storage requirement of the computer application.

3. A method according to claim 2, wherein the determination involves obtaining minimum storage requirement from a user of the computer application or from the computer application itself.

4. A method according to claim 1, further comprising, prior to the provisioning step, identifying storage policy applicable to the computer application.

5. A method according to claim 1, wherein the storage policy may apply to more than one or a group of computer applications.

6. A method according to claim 5, wherein the computer applications are grouped together based on: type of computer applications, a user associated with the computer applications and/or an organization's policies.

7. A method according to claim 1, wherein the provisioning of additional storage to the computer application is made on at least one storage device, identified in the storage policy applicable to the computer application.

8. A method according to claim 7, wherein the at least one storage device is categorized based on its cost and the additional storage to a computer application is provisioned based on the cost of the storage device.

9. A method according to claim 7, wherein the provisioning of additional storage to the computer application on at least one storage device is based on the criticality of the computer application.

10. A system for provisioning additional storage to a computer application comprising:
a memory to store machine readable instructions; and
a processor to execute the machine readable instructions, the machine readable instructions comprising:
a monitoring module to monitor storage usage of the computer application to ascertain when a minimum storage requirement of the computer application is reached; and
a provisioning module to provision additional storage to the computer application, based on a storage policy applicable to the computer application, once the minimum storage requirement of the computer application is reached.

11. A system according to claim 10, wherein the machine readable instructions further comprises a policy module to identify storage policy applicable to the computer application.

12. A system according to claim 10, further comprising an input device to obtain minimum storage requirement of the computer application.

13. A system according to claim 10, wherein the system is a storage server arranged to provision additional storage to a computer application, based on a storage policy applicable to the computer application, once the minimum storage requirement of the computer application is reached.

14. A computer program comprising computer readable means adapted to execute the method of claim 1 when said program is run on a computer system.

15. A computer program according to claim 14 embodied on a computer readable storage medium.
